(19) United States
(12) Patent Application Publication
(10) Pub. No.: US 2002/0136625 A1
(43) Pub. Date: Sep. 26, 2002

(54) Lifting apparatus for special-purpose vehicle

(76) Inventor: Moon Hak Namgung, Incheon-City (KR)

Correspondence Address: Jonathan Y Kang, Lee & Hong, 11th Floor, 221 North Figueroa Street, Los Angeles, CA, 90012-2601, US

(21) Appl. No.: 09/913,303

(22) PCT Filed: Dec. 13, 2000
(86) PCT No.: PCT/KR00/01448

(30) Foreign Application Priority Data
Dec. 13, 1999 (KR) 1999-57063
Apr. 5, 2000 (KR) 2000-23884

(51) Int. Cl. B60P 3/07

(52) U.S. Cl. 414/563

(57) ABSTRACT

The present invention relates to a lifting device for special vehicle, and especially is provided with a lifting part (20) on a body frame (10) of tow car for lifting and carrying other vehicle to be towed and loads on the pallet from a side thereof, so that the vehicle could be towed rapidly without the release of a side brake, which is performed to tow an illegally parked vehicle, the traffic regulation could be reinforced by towing the vehicle without a front or rear space, and considerable loads could be carried.

### TECHNICAL FIELD

The present invention relates to a lifting device for special vehicle, more specifically the lifting device for special vehicle for lifting and carrying other vehicle to be towed and loads on the pallet from a side thereof.

### BACKGROUND ART

A special vehicle is a vehicle having devices of special function, and a trailer, crane and tow car are the special vehicle.

In the above special vehicle, the tow car 1 is to carry an illegally parked car and damaged car, and as shown in FIG. 1, lifts and tows a front part or rear part of a vehicle 2 which is parked illegally in line at one side of road L or has a trouble, using its tripod and crane device.

To tow the vehicle 2, a lock of tire thereof should be released, and for this, a driver of the tow car 1 releases a side brake of the vehicle to 2 be towed after opening a door thereof.

However, discretionary opening the door of the vehicle 2 by the driver of the tow car 1 causes a scratch or a breakage of door lock, and leaves the vehicle 2 to be parked illegally, if the door is not opened and the side brake is not released.

Also, in order to tow the vehicle 2, a space is required in front or rear of the vehicle 2, and if a necessary space not given, the vehicle 2 should be towed in a side thereof. This disturbs the traffic of other vehicles and increases the possibility of accidents.

Meanwhile, although the crane car in the special vehicles could take loads in its loading space easily, it carries fewer loads than other vehicles as its loading space is reduced due to the crane. The crane car could be an auxiliary vehicle for loading such as a forklift truck, but it is not preferable for a vehicle for loading only.

### DISCLOSURE OF INVENTION

The present invention is contemplated to solve the aforementioned problem, and it is an object of the present invention to provide a lifting device for a special vehicle, which lifts and carries a vehicle to be towed and loads on the pallet from a side, so that the vehicle could be towed rapidly without the release of a side brake, which is performed to tow a illegally parked vehicle, the traffic regulation could be reinforced by towing the vehicle without a front or rear space, and considerable loads could be carried.

To accomplish the above object, it is provided a lifting device for special vehicle comprising a lifting part including a supporter installed at both sides of a body frame of a tow vehicle, the supporter forming a cylinder-receiving groove, a step being formed at an upper part of the cylinder-receiving groove so that a projection could be engaged therewith, a transfer rest supporting plate being installed at an upper side of a first cylinder accommodated in the cylinder-receiving groove so as to be connected to the first cylinder, a transfer rest being installed on the supporting plate, a second cylinder being coupled to an upper inside of the first cylinder, a supporting foot being coupled to a rod in a lower part of the second cylinder, the supporting foot being coupled to the bracket which is formed on a corner of a guide frame joined to a projection on the a side of the supporter in order to slide up and down, so that the guide frame slides down in drawing out of the supporting foot; a guide frame including a guide plate in an opposite side to the side having the bracket on the corner, a vertical guide groove and a horizontal guide groove, a chain engaging with a sprocket which is installed to a side of an elevation plate of a step part, being installed in the vertical and horizontal guide groove; a step part including the elevation plate, a supporting plate, and a transfer plate and being installed to be accommodated in the lifting part, an elevation stand having a pair of supporting stand of which a center portion coupled with a hinge, being installed between the elevation plate and supporting plate, each end of the supporting stands being coupled rotatably to the elevation plate and the supporting plate, rollers being installed to other ends of the supporting stand respectively, these rollers being coupled slidably along with the elevation plate and supporting plate respectively, the supporting stands being erected rotating in opposite direction about the hinge with the extension of the cylinder and lifting the elevation plate, a first motor being installed to one side of the elevation plate, a shaft having a sprocket on an end thereof being installed rotatably to a side of the first motor with a pulley or chain, the sprocket on the end of the shaft being engaged with the chain installed in the vertical and horizontal guide grooves of the guide frame, the sprocket traveling along with the chain by the rotation of the first motor and simultaneously the elevation plate being drawn out from the inner space of the lifting part, a chain being installed on both sides of the elevation plate, the chain being connected with a shaft which is connected with the second motor by pulley or chain so as to drive like a caterpillar; and a transfer rest being installed to the upper part of the body frame, a chain being installed on both sides of the transfer rest, the chain being connected with a shaft which is connected with a third motor on the body frame by pulley or chain so as to drive like a caterpillar by the rotation of the third motor.

### BRIEF DESCRIPTION OF THE DRAWINGS

The features and advantages of the present invention will be more described specifically in the following description of preferred embodiments of the invention with reference to the accompanying drawings wherein:

FIG. 1 is a plan view for describing a towing method of a tow car in the prior special vehicle;

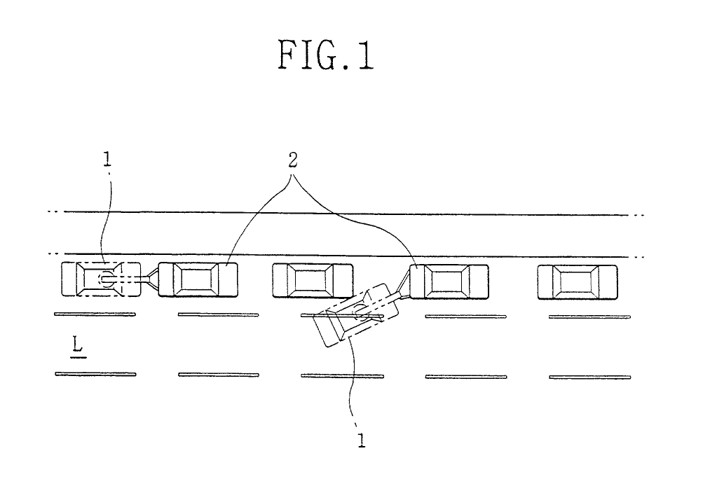

FIG. 2 is a perspective view showing a structure of the present invention;

FIG. 3 is an exploded perspective view showing a structure of a lifting part according to the present invention;

FIG. 4 is an exploded perspective view showing a structure of a step part according to the present invention;

FIG. 5 is a side view showing a preparation status for towing a vehicle using the lifting device of the present invention;

FIG. 6 a sectional view showing an operation status of the lifting part according to the present invention;

FIG. 7 is a side view showing a status for lifting the vehicle by drawing out the step part of the present invention;

FIG. 8 is a side view showing a status in which the vehicle is lifted using the lifting part of the present invention; and

FIG. 9 is a side view showing a status for transferring a supporter in which the vehicle to be towed is loaded, to a tow car using a transfer rest of the present invention.

### BEST MODE FOR CARRYING OUT THE INVENTION

Reference will now be made in detail to the embodiment of the present invention and examples of which are illustrated in the accompanying drawings. In explaining the present invention, the same names and reference numerals will be given to the same components, and explanations in the same will be omitted.

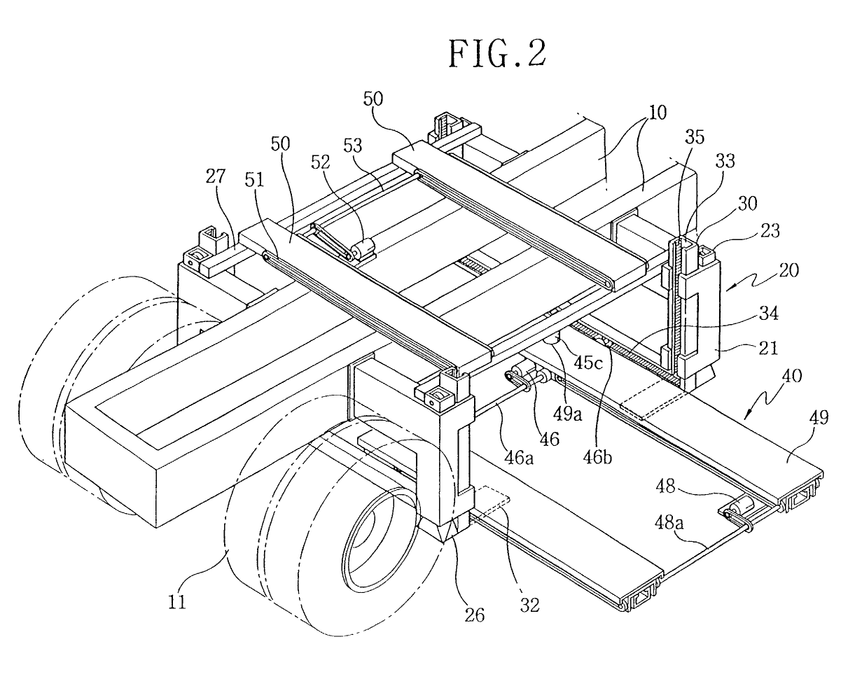

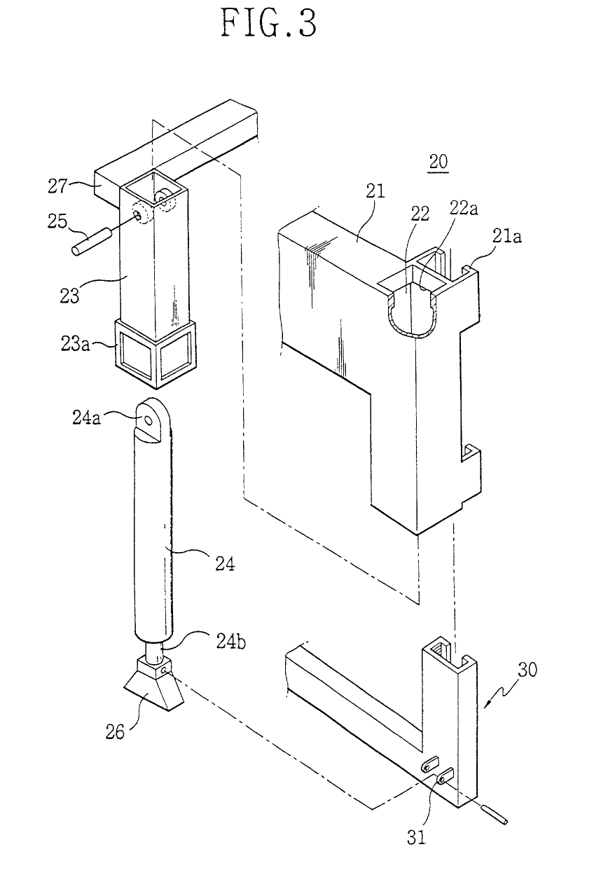

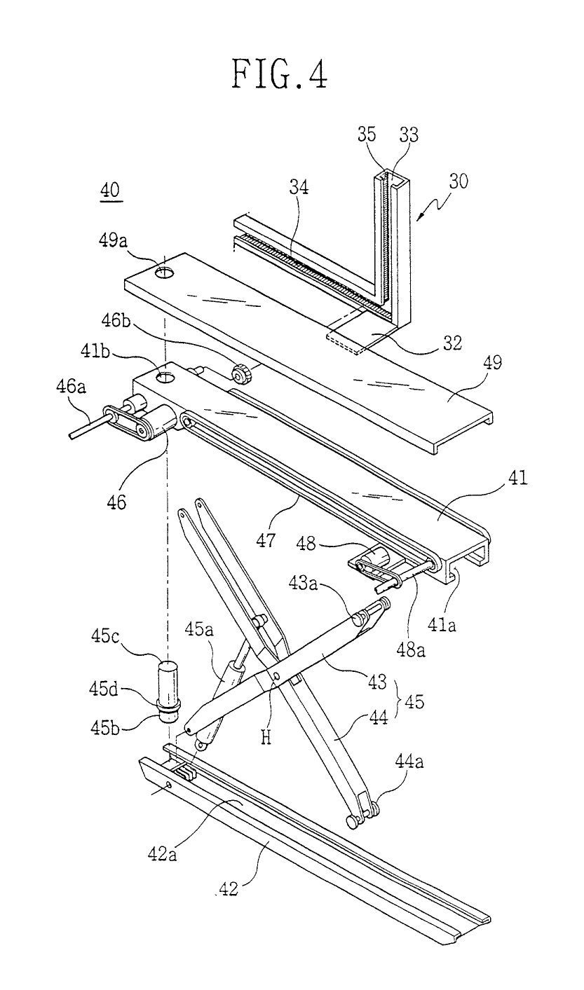

FIG. 2 illustrates a perspective view showing a structure of the present invention, FIG. 3 illustrates an exploded perspective view showing a structure of lifting part according to the present invention, and FIG. 4 is an exploded perspective view showing a structure of a step part according to the present invention respectively.

A reference numeral 10 is a body frame of a tow car, and a supporter 21 is installed symmetrically at both sides of this body frame 10 not to disturb a rotation of wheels 11.

The supporter 21 forms a cylinder-receiving groove 22 with one end extending downwardly as shown in FIG. 3 and at an upper part of the cylinder-receiving groove 22, a step 22a is formed so that a projection 23a could be engaged therewith.

At an upper side of a first cylinder 23 accommodated in the cylinder-receiving groove 22, a transfer rest supporting plate 27 is installed to be connected to the first cylinder 23, and a transfer rest 50 is installed on the supporting plate 27, so that the transfer rest 50 is elevated when the first cylinder 23 is extended upwardly.

A hinge 24a formed at an upper part of a second cylinder 24 is coupled to an upper inside if the first cylinder 23 with a pin 25, and a supporting foot 26 is coupled to a rod 24b in a lower part of this second cylinder 24.

The supporting foot 26 is coupled to the bracket 31 which is formed on a corner of a guide frame 30 joined to slide up and down to a projection 21 on the a side of the supporter 21, so that the guide frame 30 slides down in drawing out of the supporting foot 26 and rod 24b, and thus a lifting part 20 is constructed entirely.

In an opposite side to the side having the bracket 31 on the corner, the guide frame 30 includes a guide plate 32, a vertical guide groove 33 and a horizontal guide groove 34. The guide plate 32 supports the drawing out of a step part 40 and has a size that could support this step part 40 to be drawn out stably. In the vertical and horizontal guide groove 33, 34, a chain 35 engaging with a sprocket 46b which is installed to a side of an elevation plate 41 of the step part 40, is installed.

The step part 40 comprises a pair opposite each other with a width enough to lifting the vehicle and is installed to be accommodated in the lifting part 20, and thus is described referring only one part thereof as shown in FIG. 4. The step part 40 includes the elevation plate 41, a supporting plate 42, and a transfer plate 49, and between the elevation plate 41 and supporting plate 42, an elevation stand 45 having a pair of supporting stand 43, 44 of which a center portion is coupled with a hinge H, is installed.

It is preferable that the supporting stands 43, 44 of the elevation stand 45 are formed not to interfere with each other in the operation.

In the supporting stands 43, 44 of the elevation stand 45, one end of the supporting stand 43 is coupled rotatably to the supporting plate 42, and one end of the supporting stand 44 is coupled rotatably to the elevation plate 41. Further, rollers 43a, 44a are installed to other ends of the supporting stand 43, 44 respectively, and these rollers 43a, 44a are coupled slidably in guide grooves 41a, 42a formed along with the elevation plate 41 and supporting plate 42 respectively.

It is preferable that the in the guide grooves 41a, 42a of the elevation plate 41 and supporting plate 42, their end are bent inwardly to prevent the separation of the rollers 43a, 44a.

An end portion of a cylinder 45a is coupled rotatably near one side of an end portion of the supporting plate 42, and other end portion of the cylinder 45a is coupled rotatably near a center portion of the supporting stand 44.

Also, a reciprocating auxiliary cylinder 45b to assist the operation of the cylinder 45a is fixed normally to the supporting plate 42, a supporting cap 45c is coupled to an upper part of the auxiliary cylinder 45b, and a projection 45d is formed on an outer circumferential surface of a lower part in the supporting cap 45c. And, the supporting cap 45c is inserted separably into holes 41b, 49b formed in the elevation plate 41 and transfer plate 49, and the projection 45d is located beneath the hole 41b, so that in the lifting operation of the auxiliary cylinder 45b, the projection 45d come into contact with a bottom surface of the elevation plate 41.

Due to the structure mentioned above, when the cylinder 45a and auxiliary cylinder 45b are extended, the elevation plate 41 is lifted together with the transfer plate 49 by the auxiliary cylinder 45b initially. Then, when the cylinder 45a is inclined, the supporting stands 43, 44 are erected rotating in opposite direction about the hinge H and lifts the elevation plate 41 and transfer plate 49. And, in this operation, each roller 43, 44 slides guided by each guide groove 41a, 42a of the elevation plate 41 and supporting plate 42.

A first motor 46, the power source to draw out the step part 40 from an inner space of the lifting part 20 is installed to one side of the elevation plate 41, a shaft 46a having a sprocket 46b on an end thereof is installed rotatably to a side of the first motor 46 with a pulley or chain, and the sprocket 46b on the end of the shaft 46a is engaged with the chain 35 installed in the vertical and horizontal guide grooves 33, 34 of the guide frame 30. Accordingly, the sprocket 46b travels along with the chain 35 by the rotation of the first motor 46, and simultaneously the elevation plate 41 is drawn out from the inner space of the lifting part 20.

As the sprocket 46b installed to be engaged with the chain 35 in the vertical and horizontal guide grooves 33, 34 of the guide frame 30, is to draw out the step part 40 from the inner space of the lifting part 20, it could be replaced by a power-driven device which is operated with a rack and pinion or a hydraulic device which is operated with a piston.

A chain 47 is installed on both sides of the elevation plate 41 so as to move the transfer plate 49 to the transfer rest 50 installed to the upper part of the body frame 10 of the tow car, and this chain 47 is connected with a shaft 48a which is connected with the second motor 48 by pulley or chain so as to drive like a caterpillar.

The transfer rest 50 is installed to the upper part of the body frame 10, a chain 51 is installed on both sides thereof, this chain 51 is connected with a shaft 53 which is connected with a third motor 52 on the body frame 10 by pulley or chain so as to drive like a caterpillar by the rotation of the third motor 52.

The width of the transfer rest 50 is preferably identical to the width of the step part 40 so that the transfer plate 49 moves to the transfer rest 50 safely without separation.

The operation of the lifting device according to present invention will be explained in detail as follows.

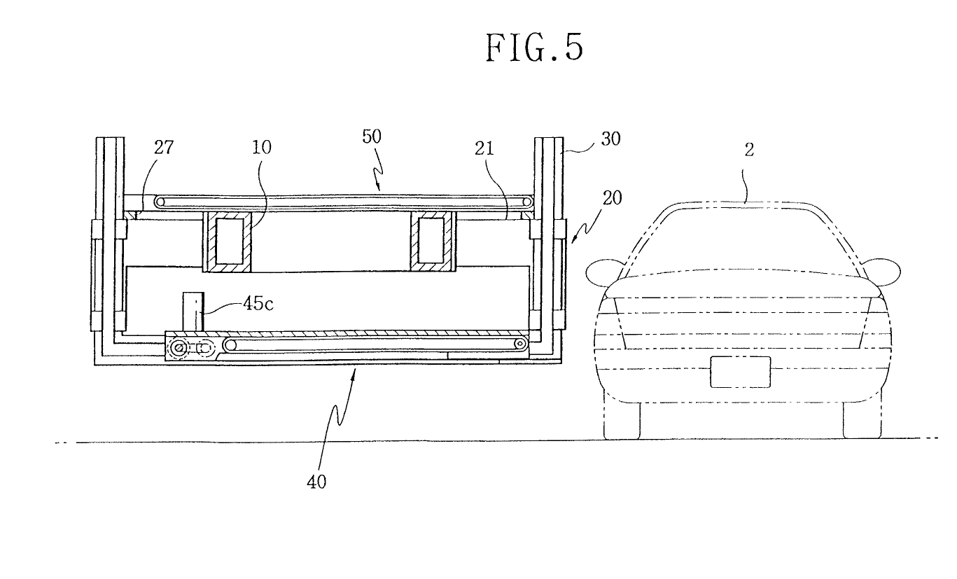

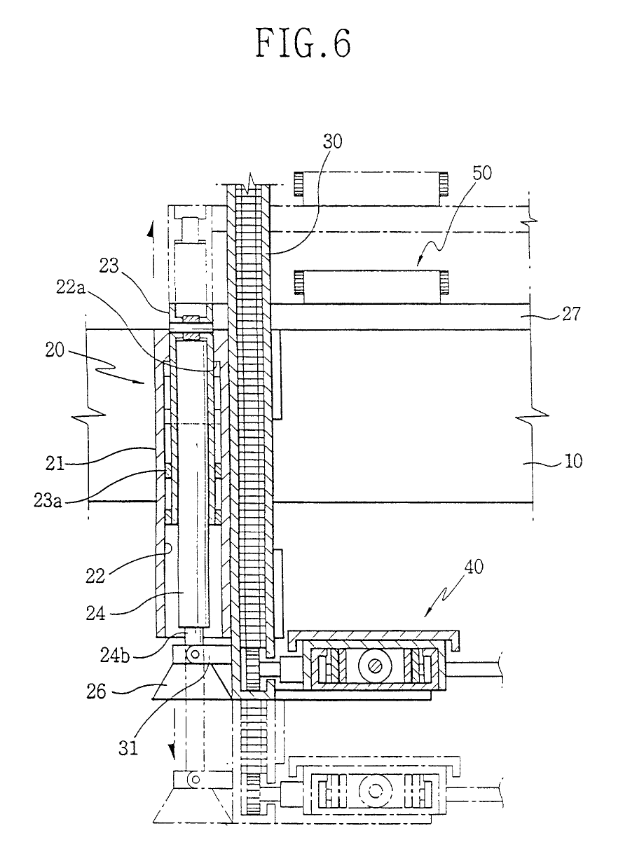

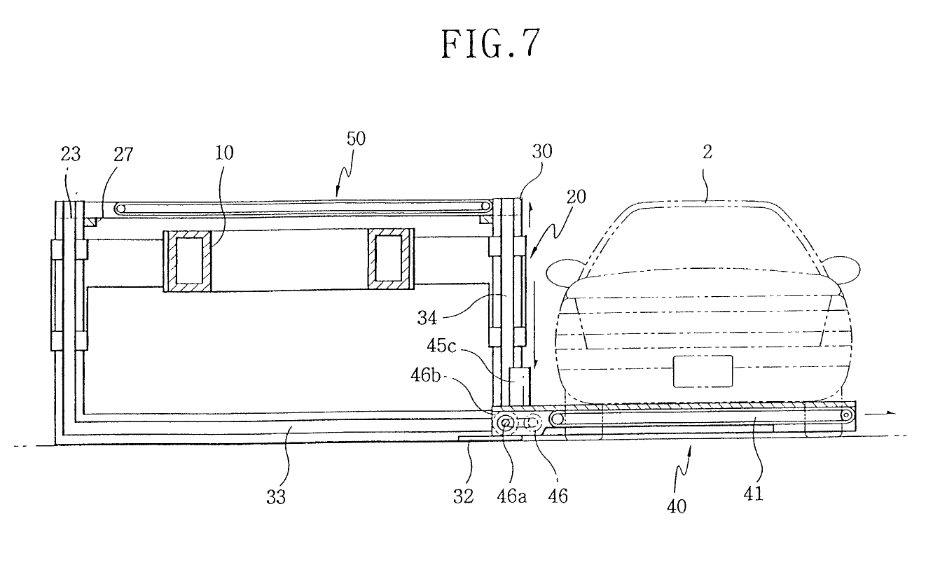

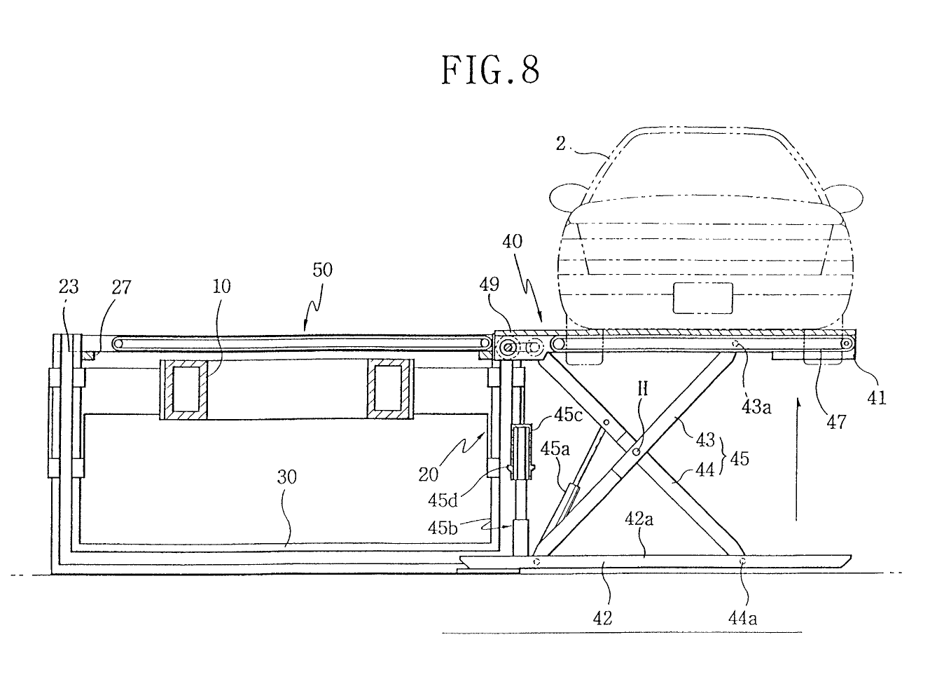

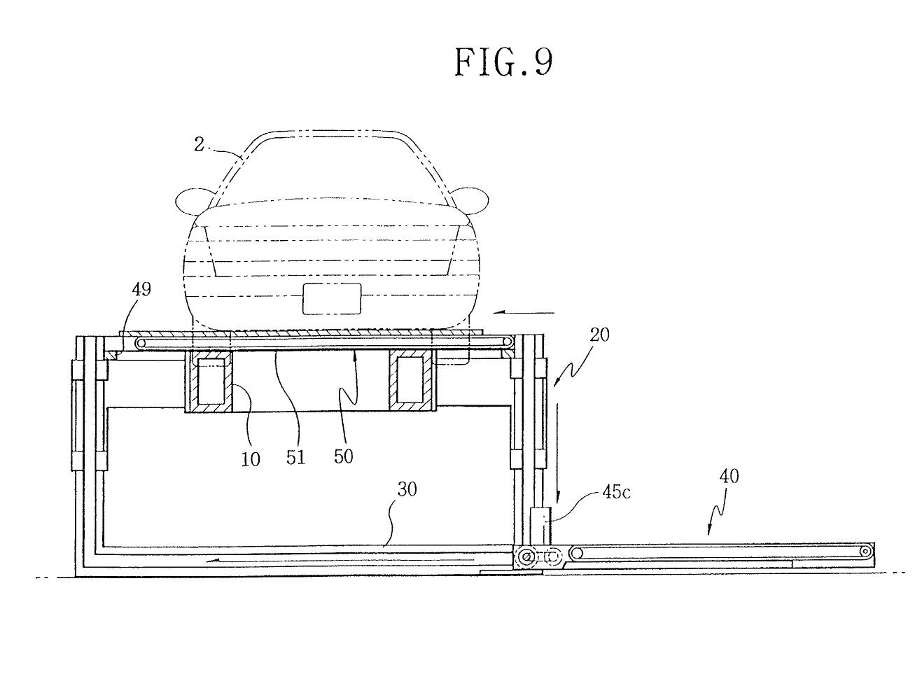

FIG. 5 illustrates a side view showing a preparation status for towing a vehicle using the lifting device of the present invention, FIG. 6 illustrates a sectional view showing an operation status of the lifting part according to the present invention, FIG. 7 illustrates a side view showing a status for lifting a vehicle by drawing out the step part of the present invention. FIG. 8 illustrates a side view showing a status which a vehicle is lifted using the lifting part of the present invention, and FIG. 9 illustrates a side view showing a status for transferring a supporter in which a vehicle to be towed is loaded, to a tow car using a transfer stand of the present invention respectively.

To tow an illegally parked or damaged car, or carry loads on the pallet by using the lifting device installed on the body frame 10 of the tow car, when the second cylinder 24 which is accommodated in the cylinder receiving groove 22 of the supporter 21 in the lifting part 20, is operated by a switch after parking the tow car on one side of the vehicle 2 to be towed as shown in FIG. 5, the rod 24b coupled to the lower part of the second cylinder 24 and the first cylinder 23 coupled to the upper part thereof move apart upwardly and downwardly, and then the first cylinder 23 is drawn out upwardly and the rod 24b is drawn out to the ground.

Simultaneously, the transfer rest 50 which is installed to the supporting plate 27 installed to the upper part of the first cylinder 23, is elevated so as not to be interfered with other devices in taking the vehicle 2 or loads on the pallet.

This operation continues until the projection 23a of the first cylinder 23 is engaged with the step portion 22a formed in the upper inside of the cylinder receiving groove 22, and the supporting foot 26 coupled to the rod 24b makes contact with the ground.

When the supporting foot 26 is drawn out by the rod 24b as described above, the (guide frame 30 coupled to this supporting foot 26 by the bracket 31 formed on the corner part thereof, slides downwardly.

When the guide frame 30 slides downwardly and comes in contact with the around, as shown in FIG. 7, the first motor 46 installed on one side of the elevation plate 41 of the step part 40 is operated by using a switch and rotates the shaft 46a. And, as the sprocket 46b installed to the end of the shaft 46a rotates and moves along the chain 35 installed in the vertical and horizontal guide groove 33, 34 of the guide frame 30, the step part 40 is drawn out from the inner space of the lifting part 20 and inserted to the side of the vehicle 2.

At this time, the step part 40 is drawn out stably guided by the guide plate 32 installed to the guide frame 30.

Then, when the cylinder 45a and auxiliary cylinder 45b is operated, the supporting stands 43, 44 rotate in opposite direction about the hinge H, and each roller 43a, 44a installed to the supporting stand 43, 44 slides guided by the groove 41a, 42a of the elevation plate 41 and supporting plate 42 and lifts the elevation plate 41 upwardly, and thereby the vehicle 2 is loaded on the step part 40 and lifted.

The rollers 43a, 44a of the supporting stands 43, 44 slide in the guide grooves 41a, 42a of the elevation plate 41 and supporting plate 42 without separation, since the ends of the guide grooves 41a, 42a are bent inwardly.

When the vehicle 2 is lifted upwardly as mentioned above, as shown in FIG. 9, the second motor 48 installed to the elevation plate 41 is operated by the switch and rotates the chain 47 installed to both sides of the elevation plate 41, and then due to the rotation of the chain 47, the transfer plate 49 on the elevation plate 41 moves to the transfer rest 50 installed on the body frame 10 of the tow car.

Then, the third motor 52 rotates the chain 51 of the transfer rest 50 on the body frame 10, so as to move the transfer plate 49 to the transfer rest 50 continuously.

At this time, since the vehicle 2 is loaded on the transfer plate 49, the vehicle 2 is moved from the step part 40 to the transfer rest 50 by the movement of the transfer plate 49.

When the movement of vehicle 2 from the step part 40 to the transfer rest 50 is completed, the step part 40 is drawn in the inner space of the lifting part 20 by operating reversely, and the towing operation is completed.

The above description is merely restricted to the towing of the vehicle 2, and the loads on the pallet could be loaded by way identical to the above.

It will be apparent to those skilled in the art that various modifications and variations can be made in the fin tube type evaporator in an air conditioner of the present invention without departing from the spirit or scope of the invention. Thus, it is intended that the present invention cover the modifications and variations of this invention provided they come within the scope of the appended claims and their equivalents.

The Industrial Applicability

As explained above, the present invention provides a lifting device for lifting and carrying vehicle to be towed and loads on the pallet from a side. Therefore, the vehicle could be towed rapidly, since the release of a side brake, which is performed to tow a illegally parked vehicle is not required. And, the traffic regulation could be reinforced, since the vehicle is towed without a front or rear space. Further, since the present invention allows considerable loads to be carried and could be applied according to the purpose of use, both towing and carrying purpose are satisfied.

1. A lifting device for special vehicle comprising;
a lifting part (20) including a supporter (21) installed at both sides of a body frame (10) of a tow vehicle, the supporter (21) forming a cylinder-receiving groove (22), a step (22a) being formed at an upper part of the cylinder-receiving groove (22) so that a projection (23a) could be engaged therewith, a transfer rest supporting plate (27) being installed at an upper side of a first cylinder (23) accommodated in the cylinder-receiving groove (22) so as to be connected to the first cylinder (23), a transfer rest (50) being installed on the supporting plate (27), a second cylinder (24) being coupled to an upper inside of the first cylinder (23), a supporting foot (26) being coupled to a rod (24b) in a lower part of the second cylinder (24), the supporting foot (26) being coupled to the bracket (31) which is formed on a corner of a guide frame (30) joined to a projection (21a) on the a side of the supporter (21) in order to slide up and down, so that the guide frame (30) slides down in drawing out of the supporting foot (26);
a guide frame (30) including a guide plate (32) in an opposite side to the side having the bracket (31) on the corner, a vertical guide groove (33) and a horizontal guide groove (34), a chain (35) engaging with a sprocket (46b) which is installed to a side of an elevation plate (41) of a step part (40), being installed in the vertical and horizontal guide groove (33, 34);
a step part (40) including the elevation plate (41), a supporting plate (42), and a transfer plate (49) and being installed to be accommodated in the lifting part (20), an elevation stand (45) having a pair of supporting stand (43, 44) of which a center portion coupled with a hinge (H), being installed between the elevation plate (41) and supporting plate (42), each end of the supporting stands (43, 44) being coupled rotatably to the elevation plate (41) and the supporting plate (42), rollers (43a, 44a) being installed to other ends of the supporting stand (43, 44) respectively, these rollers (43a, 44a) being coupled slidably along with the elevation plate (41) and supporting plate (42) respectively, the supporting stands (43, 44) being erected rotating in opposite direction about the hinge (H) with the extension of the cylinder (45a) and lifting the elevation plate (41), a first motor (46) being installed to one side of the elevation plate (41), a shaft (46a) having a sprocket (46b) on an end thereof being installed rotatably to a side of the first motor (46) with a pulley or chain, the sprocket (46b) on the end of the shaft (46a) being engaged with the chain (35) installed in the vertical and horizontal guide grooves (33, 34) of the guide frame (30), the sprocket (46b) traveling along with the chain (35) by the rotation of the first motor (46) and simultaneously the elevation plate (41) being drawn out from the inner space of the lifting part (20), a chain (47) being installed on both sides of the elevation plate (41), the chain (47) being connected with a shaft (48a) which is connected with the second motor (48) by pulley or chain so as to drive like a caterpillar; and
a transfer rest (50) being installed to the upper part of the body frame (10), a chain (51) being installed on both sides of the transfer rest (50), the chain (51) being connected with a shaft (53) which is connected with a third motor (52) on the body frame (10) by pulley or chain so as to drive like a caterpillar by the rotation of the third motor (52).

2. A lifting device according to claim 1, wherein the sprocket (46b) installed to be engaged with the chain (35) in the vertical and horizontal guide grooves (33, 34) of the guide frame (30), is a hydraulic device which is operated with a piston, instead of a power-driven device.

3. A lifting device according to claim 1 or claim 9, wherein an auxiliary cylinder (45b) is installed between the elevation plate (41) and the supporting plate (42), so that initial lifting is given to the elevation plate (41).
